(19) United States
(12) Patent Application Publication
(10) Pub. No.: US 2014/0257963 A1
(43) Pub. Date: Sep. 11, 2014

(54) TECHNIQUES FOR DELIVERING HOTEL SERVICES

(71) Applicant: Edward Dwight Landis, Independence, KY (US)

(72) Inventor: Edward Dwight Landis, Independence, KY (US)

(21) Appl. No.: 13/785,459

(22) Filed: Mar. 5, 2013

(51) Int. Cl. H04W 4/02

(52) U.S. Cl. CPC H04W 4/02
USPC 705/14.36; 455/456.3; 705/14.64; 705/14.45

(57) ABSTRACT

Techniques delivering hotel-based services are provided. Hotel and services providers use portal interfaces to register and define content and services to consumers. Instances of apps are dynamically made available to consumers; the apps provide on demand automated and controlled access to the content and services from mobile devices of the consumers.

### BACKGROUND

Increasingly consumers are transacting via mobile devices. Specifically, consumers are using phones and tablets to perform a variety of communication and transactional operations in their daily lives. More and more, consumers are using their phones for navigation, coupon collection and redemption, product and service identification, loyalty card management, product and service recommendations, payment for product and services, and others.

In fact, a physical location of a consumer no longer really matters and the consumer does not have to have a full-fledged computer to perform any transactional or computational needs of the consumer.

However, one area that has not substantially integrated mobile technology into its business model and practices to any real degree is the hotel industry. Consumers still have to call the front desk, housekeeping, food services, and the concierge of the hotel for a variety of reasons. This is inconvenient for the hotel staff and for the consumer. Still further, many times a consumer may not be able to locate the hotel guest book in his/her room either because it is not readily noticeable or because housekeeping neglected to replace a missing copy. As a result, the consumer will call the front desk for a new copy or for basic information that should typically not require consultation with the hotel staff. For a hotel that is at or near capacity, the calls to the front desk and the various units of the hotel can become overwhelming and any significant delays in the responsiveness of the hotel staff can have adverse impacts on the business reputation of the hotel.

Hotels also find it difficult and expensive to keep guest books up to date in the rooms. Consider that one minor change necessitates a new printed page and integration into each room. Still further, many hotel guests may not speak the native language that the guest book is printed in.

Thus, the hotel industry needs to more efficiently integrate with existing practices of its consumers and with prevailing technology available in the industry.

### SUMMARY

In various embodiments, techniques for delivering hotel services are presented. According to an embodiment, a method for delivering hotel services is provided.

Specifically, a current location for a mobile device is determined and hotel is proposed to a user. Next, a confirmation is received from the user, via the mobile device, for the proposed hotel and the method processing is configured as an app to deliver on demand information and services relevant to the hotel and a surrounding area of the hotel from the mobile device.

### BRIEF DESCRIPTION OF THE DRAWINGS

FIG. 1 is a diagram of a method for delivering hotel services, according to an example embodiment.

FIG. 2 is a diagram of another method for delivering hotel services, according to an example embodiment.

FIG. 3 is a diagram of a hotel delivery service system, according to an example embodiment.

### DETAILED DESCRIPTION

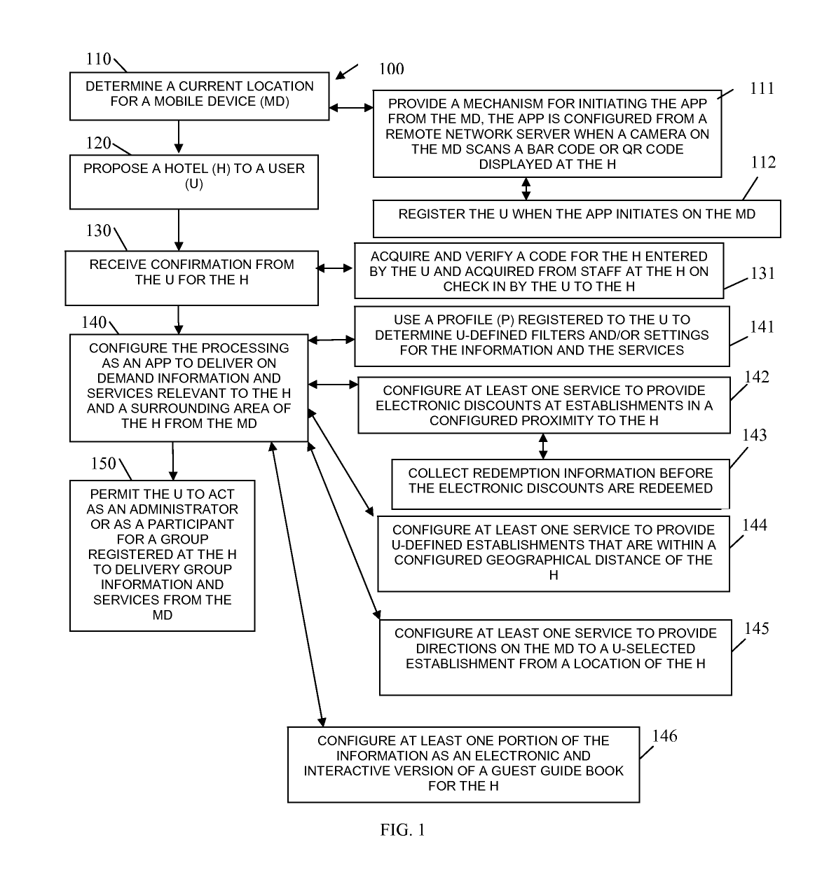

FIG. 1 is a diagram of a method 100 for delivering hotel services, according to an example embodiment. The method 100 (hereinafter “mobile hotel agent service”) is implemented as instructions residing on or programmed within memory and/or a non-transitory computer-readable (processor-readable) storage medium and executed by one or more processors. The processors are specifically configured and programmed to process the mobile hotel agent service. The mobile hotel agent service operates over a network. The network is wired, wireless, or a combination of wired and wireless. In an embodiment, the network is cellular, WiFi, or Satellite.

In an embodiment, the mobile hotel agent service executes on one or more processors over the network on a server or in a cloud processing environment. In such a case, the processing occurs remote from a mobile device of a consumer (the term “consumer” may be used interchangeably and synonymously with the term “user” herein and below) and is delivered via web browser pages and/or plugins accessible via the consumer's mobile device.

Cloud computing is often defined as computing capabilities that provide an abstraction between computing resources and the underlying technical architecture (e.g., servers, storage, networks), enabling convenient, on-demand network access to a shared pool of configurable computing resources that can be rapidly provisioned and released with minimal management effort or service provider interaction. From the perspective of the user, where and how a computing resource is irrelevant and transparent in cloud computing.

As used herein a “cloud processing environment” refers to a set of cooperating computing resources, such as machines, storage, software libraries, software systems, etc. that form a logical computing infrastructure.

In another instance, the mobile hotel agent service processes on multiple different devices and processors. This can occur via a web-based browser implementation of the mobile hotel agent service where some plugins are processed on the user's mobile device while other functions of the mobile hotel agent service is processed remotely on the server or cloud processing environment.

In still another embodiment, the mobile hotel agent service processes within a self-contained app that is distinct from the browser of the consumer's mobile device. That is, an app independent of the mobile device's browser provides processing for the mobile hotel agent service wholly on the consumer's mobile device. This scenario is similar to existing mobile app technology.

However, as used herein “mobile app” can refer to a traditional self-contained app on a mobile device or can refer to a service available via an existing app on the mobile device, such as a mobile device's web browser.

At 110, the mobile hotel agent service determines a current location for a mobile device. That is, the mobile hotel agent service is given permission by the user during initial setup to access location services of the mobile device for which the mobile hotel agent service executes or is being directed. So, when the mobile hotel agent service is initiated on the mobile device a current location for the mobile device is resolved.

According to an embodiment, at 111, the mobile hotel agent service provides a mechanism for initiating the app from the mobile device. In one case, the app is configured from a remote network server when the user directs a camera of the mobile device to a bar code or a Quick Response (QR) code and scans that code. This causes the app to be downloaded and/or configured and initiated on the mobile device. The bar code or QR code can be prominently displayed at the front desk of the hotel or in various areas throughout the hotel inviting or enticing the user/consumer to scan the code to acquire and initiate the app.

In another case, a web browser can be used to enter a Universal Resource Locator (URL) link into the address bar of the browser where the URL provides an interface for downloading and initiating the app on the mobile device. In some cases, just a link appears on the mobile device where that link (URL) automatically initiates the mobile device's web browser and starts the app (which is a series of web pages and/or plugins). In other cases, the user can be visiting one website and see the URL and activate the URL via a click to acquire the app.

Again, the app can be a traditional mobile app that is self-contained and downloaded to the mobile device or it can be an app that is available via a web browser (another type of mobile app) of the mobile device.

Continuing with the embodiment of 111 and at 112, the mobile hotel agent service registers the user when the app initiates on the mobile device of the user for a first time. Registration can be optional but when performed from the user a variety of additional service become available, such as profile development, automated loyalty processing on behalf of the user, and the like. An interface can be presented to the user for interacting with the user and performing the registration. In some cases, the user can achieve the registration unbeknownst to the user because the mobile device will have an Internet Protocol (IP) address, Media Access Control (MAC) identifier, and/or a phone number that can be noted and uniquely tied to the user. In still other situations, the user may enter a loyalty account to the hotel and based on relationships with the hotel, the user is automatically registered to the mobile hotel agent service and a profile is automatically created based on backend communications with a loyalty server of the hotel for which the loyalty account of the user exists.

At 120, the mobile hotel agent service proposes a hotel to the user. This can be done based on the current location of the mobile device or can be done based on the user entering a specific hotel address and/or phone number. In the latter case, the user need not be physically at the hotel to initiate the features that follow. This situation may be particularly beneficial when the user is investigating a hotel to make reservations at or when the user is pre-planing various activities to a hotel that the user is scheduled to check into.

At 130, the mobile hotel agent service receives confirmation from the user for the hotel. So, based on the current location of the mobile device or based on user inputted information to the app, one or more available or likely hotels are presented to the user via the app. The user then selects a specific hotel that the user wants to use with the app.

According to an embodiment, at 131, the mobile hotel agent service acquires and verifies a code for the user that is entered into the app by the user. In some instances, this code may be acquired from staff of the hotel directly or indirectly (such as on check-in materials, via a sign, etc.). This code can be used for a variety of purposes. One code may be associated with the encrypted WiFi access code that the user needs to access the hotel's Internet Services. In another case, the code may be to enable services that require security, such as hotel bill review and payment services or ordering hotel products or services while at the hotel via the app. In still another case, the code can be a specific phone number for a specific desired hotel that the user wants information on via the app. As will be discussed later, the code may also be a group collaboration code that provides access for group collaboration in a secure manner via the app.

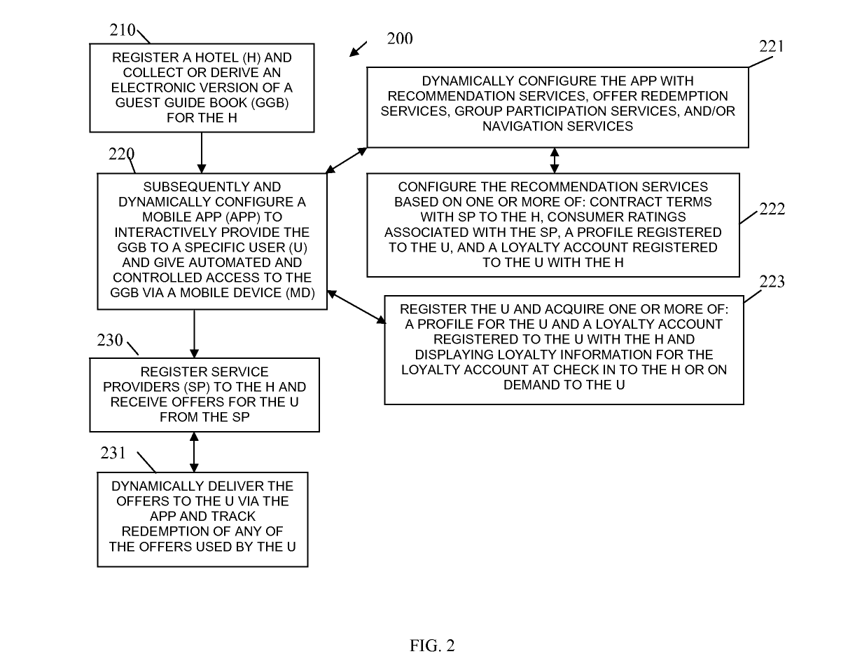

At 140, the mobile hotel agent service configures the processing discussed heretofore as the app, which delivers on demand information and services relevant to the hotel and a surrounding area of the hotel from the mobile device of the user. What is relevant can be defined via a hotel portal (discussed below with reference to the FIG. 2). Moreover, the surrounding area can be configured to be a predefined or dynamically user-defined or administrator-defined geographic range to the hotel and its known physical location.

In an embodiment, at 141, the mobile hotel agent service uses a profile for the user to determine user-defined filters and settings for the information and services presented in the app. Here, a profile for the user can alter how results of searches are sorted and even what results are presented. Moreover, the settings can determine what types of services or offers are even available to the user. The profile can be derived based on prior interactions noted with the user and/or can be defined and updated on demand by the user.

According to an embodiment, at 142, the mobile hotel agent service is configured to provide at least one of the services as a service that provides electronic discounts for goods or services within a configured proximity to the hotel. That is, promotions or discounts can be targeted by the hotel and/or by service providers independent of the hotel and made available via the app to the user. The delivery, redemption, and tracking of these promotions, offers, and/or discounts can be handled in an automated fashion with automated processing via the mobile hotel agent service (app).

So, continuing with the embodiment of 142 and at 143, the mobile hotel agent service collects redemption information before electronic discounts are redeemed. For example, a coupon is delivered, via the app, for a particular establishment or service provider that coupon includes a code for the hotel indicating it is related to the hotel. The user may then have to verify by presenting a hotel key or presenting via the app an indication that the user is checked into the hotel. This may be particular useful when the establishment just wants to market to hotel guests. This marketing can even be achieved for specific groups within the hotel if the establishment wants to offer discounts to specific groups. In some cases, the discount can be presented after the user receives a code from the establishment; this may be useful for the hotel to track redeemed offers at specific recommended establishments. Again, the hotel can recommend establishments (service providers) and/or the establishments can provide discounts independent or in collaboration with the hotels.

In an embodiment, at 144, the mobile hotel agent service configures at least one service to provide user-defined establishments that are within a configured distance of the hotel and as defined by the hotel. Here, a hotel portal (discussed below with reference to the FIG. 2) allows the hotel to define a name, a point on a map (service provider or establishment), provide an URL for an establishment, provide a phone number for an establishment, indicate a distance from the hotel to an establishment, and define coordinates on the map for the location of the hotel. This can be done for each establishment that the hotel wants to provide information to via the mobile hotel agent service and entered or custom defined by the hotel via a hotel portal as discussed below with reference to the FIG. 2. Once this information is available, the user then interacts with search services to select items or manually enter information to filter the available establishments based on user direction.

In another situation, at 145, the mobile hotel agent service configures at least one service to provide directions on the mobile device to a user-selected establishment from the location of the hotel. Here, an existing navigation service of the mobile device is interacted with to provide the specific directions. The coordinates for the establishments are defined by the hotel (via the hotel portal) or via a service provider (establishment—via a service provider portal) independent of the hotel. The user then makes user-defined selections and searches until a desired establishment is noted and the coordinates for the hotel and the desired establishment are then passed off to the existing navigation services to provide navigation directions to the user. In some cases, the navigation can be related to a public transit system, such as subways and buses.

In an embodiment, at 146, the mobile hotel agent service configures at least one portion of the information as an electronic and interactive version of a guest guide book for the hotel. A guest guide book provides information related to services of the hotel, such as hours of operations for the pool, location of the pool, housekeeping numbers, television channels, room service menu, airline information, taxi information, public transit information, and many others.

According to an embodiment, at 150, the mobile hotel agent service permits the user to act as an administrator or as a participant for a group registered at the hotel to deliver group information and services from the mobile device of the administrator and other group participants. This feature permits dynamic and real time collaboration between groups assembled at a hotel. Group participants use a code that automatically signs them into the group where blogs, comments, recommendations, schedules, and event information can be collaborated between members of the group.

It is noted that the mobile hotel agent provides a universal app to users that is not specific to any specific hotel and that normalizes the structure of hotel content such that users know where to look for specific information within the app independent of any specific hotel.

FIG. 2 is a diagram of another method 200 for delivering hotel services, according to an example embodiment. The method 200 (hereinafter “hotel manager”) is implemented and/or programmed as instruction within memory and/or a non-transitory computer-readable (processor-readable) storage medium that executes on one or more processors; the processors are specifically configured to execute the inferential trip assist service. The hotel manager is operational over a network; the network is wired, wireless, or a combination of wired and wireless. In an embodiment, the network is cellular, WiFi, or satellite.

The hotel manager presents processing from the perspective of a centralized service that manages interactions and transactions occurring with the mobile hotel agent service. Moreover, the hotel manager provides interfaces and interactions for gathering and organizing content and delivering services to the consumers as defined by the hotels and/or service providers to the hotels and/or consumers.

At 210, the hotel manager registers a hotel and the hotel manager also collects or derives an electronic version of a guest guide book for the hotel. Here, the guest guide book is an electronic and interactive version of information supplied at hotels that include hotel services and information. The hotel registration can be achieved by a portal for the hotel that a hotel manager or administrator uses to have the guest guide book memorialized in electronic media. The guest guide book also provides specific services that are provided electronic, such as on line recommendations, concierge recommendations, online bill review, payment services and the like.

It is to be noted that the guest guide book can be dynamically rendered in any desired spoken language. So, a hotel may translate or provide content translations for multiple different language versions of the guest guide book; or, in some cases, automated translators may permit the content of a base spoken language for the guest guide book to be dynamically rendered into a specific desired spoken language selected by an end user.

At 220, the hotel manager subsequently and dynamically configures a mobile app to interactively provide the guest guide book to a specific user and give automated and controlled access to the guest guide book via a mobile device. Example processing associated with the mobile app was provided above with reference to the FIG. 1 and the method 100.

According to an embodiment, at 221, the hotel manager dynamically configures the mobile app with recommendation services, offer redemption services, group participation services, and/or navigation services. The recommendation services can be organized according to the source recommending, such as concierge, consumers, travel advisors, organizations, and the like. Examples of redemption services and group collaboration services as well as navigation servers were presented above with reference to the FIG. 1.

Continuing with the embodiment of 221 and at 222, the hotel manager configures the recommendation services based on one or more of: contract terms with the service providers to the hotel, consumer ratings associated with the service provider, a profile registered to the user, and a loyalty account registered to the user with the hotel.

In an embodiment, at 223, the hotel manager registers the specific user and acquires one or more of: a profile for the user and a loyalty account registered to the user with the hotel and then displays that loyalty information for the loyalty account of the user at check in to the hotel or on demand to the user.

It is noted that any profile for a user can be maintained at a server associated with the hotel manager or manages in whole or in part as a cookie from the processing environment of the user.

According to an embodiment, at 230, the hotel manager registers service providers to the hotel and receives offers for the user from the service providers. Here, a service provider portal is provided that is separate from the hotel portal where service providers can define and register their services for delivery via the mobile app to the consumers checked in at hotels. This was discussed above with reference to the FIG. 1.

Continuing with the embodiment of 231 and at 232, the hotel manager dynamically delivers the offers to the specific user via the mobile app and tracks redemption of any of the offers used by the specific user. This tracking can be used by retailers for marketing campaigns or customer segmentation analysis. Additionally, the tracking can be used to enforce automated licensing and royalty fees associated with referrals to service providers and the like.

It is noted that in some cases the hotel manager can also proactively send notices to hotel or service provider personnel to remind them to validate the content of their information. Moreover, an interface can be made available via the mobile app to permit users to actively report content errors for a given hotel or service provider. So, dynamic feedback loops can be integrated into the hotel manager and the mobile apps to ensure that content is up to date as best it can be.

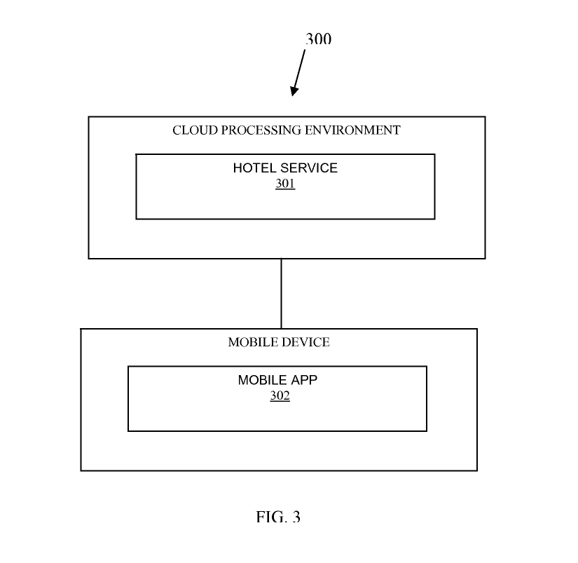

FIG. 3 is a diagram of a hotel delivery service system 300, according to an example embodiment. The hotel delivery service system 300 includes one or more processors that are specifically configured to perform, inter alia, the processing associated with the methods 100 and 200 of the FIGS. 1 and 2, respectively. The hotel delivery service system 300 may also include a variety of other hardware components, such as network adapters, memory, display screen(s), input mechanisms, and the like. Furthermore, the hotel delivery service system 300 is operational over a network and the network can be wired, wireless, or a combination of wired and wireless.

The hotel delivery service system 300 includes a hotel service 301.

The hotel delivery service system 300 includes a cloud processing environment having one or more processors with memory and/or a non transitory medium programmed with the hotel service 301. The hotel service executes on the one or more processors within the cloud processing environment. Example processing associated with the hotel service was defined above with respect to the FIG. 1 and the FIG. 2.

In an embodiment, the hotel delivery service system 300, via the cloud processing environment and the hotel service 301 dynamically delivers a mobile app 302 to a mobile device of a consumer, such as the mobile hotel agent service discussed above with respect to the FIG. 1.

In another embodiment, a different processing environment (such as existing commercial mobile app stores or portals) dynamically delivers the mobile app 302 (such as the mobile hotel agent service discussed above with respect to the FIG. 1) to the mobile device of the consumer/user.

The mobile app 302 can be implemented as a standalone traditional mobile app 302 or can be implemented within an existing mobile app of a mobile device, such as via the mobile device's web browser.

The hotel service 301 is configured to register a hotel and collect an electronic version of a guest guide book that identifies information and services for the hotel. So, a hotel registration and content defining portal is provided to an administrator or manager of a hotel to enter that hotel's electronic guest guide book (or details that are then auto configured into an interactive electronic guest guide book on behalf of the hotel). The hotel portal also permits a hotel manager or administrator to define available services, such as but not limited to check hotel bills, pay bills, group collaboration services, and the like.

The hotel service 301 is also configured to dynamically configure the mobile app 302 for a consumer, via the consumer's mobile device, with the guest guide book of the hotel. This gives automated and controlled access to the hotel's guest guide book on the mobile device of the consumer.

According to an embodiment, the hotel service 301 is further configured to register service providers associated with the hotel and track usage of those service providers as performed by the consumer via the mobile device. This tracked usage is reported back to the hotel and/or registered service providers. Here, the hotel delivery service system 300 providers service provider portal interfaces so that service providers or the hotel itself can enter offers for goods and services that are being directed to the consumer while at the hotel. This scenario was discussed above with reference to the FIG. 2.

In another instance, the hotel service 301 is configured to configure the mobile app 302 to deliver: navigation services (directions from the hotel to selected locations or directions back to the hotel from a current location of the consumer's mobile device), search services for a service provider in proximity to the hotel, recommendation services (for specific concierge selections, agency picks, and/or consumer reviews) for specific establishments within a predefined or in some cases user or hotel-defined geographic proximity to the hotel.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in memory or a non-transitory processor-readable medium and to execute on one or more processors of a device configured to execute the method, comprising:
determining a current location for a mobile device;
proposing a hotel to a user;
receiving confirmation from the user for the hotel; and
configuring the method as an app to deliver on demand information and services relevant to the hotel and a surrounding area of the hotel from the mobile device.

2. The method of claim 1, wherein determining further includes providing a mechanism for initiating the app from the mobile device, the app is configured from a remote network server when a camera on the mobile device scans a bar code or Quick Response (QR) code displayed at the hotel.

3. The method of claim 2 further comprising, registering the user when the app initiates on the mobile device.

4. The method of claim 1, wherein receiving further includes acquiring and verifying a code for the hotel entered by the user and acquired from staff at the hotel on check in by the user to the hotel.

5. The method of claim 1, wherein configuring further includes using a profile registered to the user to determine user-defined filters and/or settings for the information and the services.

6. The method of claim 1, wherein configuring further includes configuring at least one service to provide electronic discounts at establishments in a configured proximity to the hotel.

7. The method of claim 6, wherein configuring the at least one service further includes collecting redemption information before the electronic discounts are redeemed.

8. The method of claim 1, wherein configuring further includes configuring at least one service to provide user-defined establishments that are within a configured geographical distance of the hotel.

9. The method of claim 1, wherein configuring further includes configuring at least one service to provide directions on the mobile device to a user-selected establishment from a location of the hotel.

10. The method of claim 1, wherein configuring further includes configuring at least one portion of the information as an electronic and interactive version of a guest guide book for the hotel.

11. The method of claim 1 further comprising, permitting the user to act as an administrator or as a participant for a group registered at the hotel to delivery group information and services from the mobile device.

12. A processor-implemented method programmed in a non-transitory processor-readable medium and to execute on one or more processors of a server configured to execute the method, comprising:
registering a hotel and collecting or deriving an electronic version of a guest guide book for the hotel; and
subsequently and dynamically configuring a mobile app to interactively provide the guest guide book to a specific user and giving automated and controlled access to the guest guide book via a mobile device having the mobile app.

13. The method of claim 12 further comprising, registering service providers to the hotel and receiving offers for the specific user from the service providers.

14. The method of claim 13 further comprising, dynamically delivering the offers to the specific user via the mobile app and tracking redemption of any of the offers used by the specific user.

15. The method of claim 12, wherein subsequently and dynamically configuring further includes dynamically configuring the mobile app with recommendation services, offer redemption services, group participation services, and/or navigation services.

16. The method of claim 15, wherein dynamically configuring the mobile app further includes configuring the recommendation services based on one or more of: contract terms with service providers to the hotel, consumer ratings associated with the service providers, a profile registered to the specific user, and a loyalty account registered to the specific user with the hotel.

17. The method of claim 11, wherein subsequently and dynamically configuring further includes registering the specific user and acquiring one or more of: a profile for the specific user and a loyalty account registered to the specific user with the hotel and displaying loyalty information for the loyalty account at check in to the hotel or on demand to the specific user.

18. A system, comprising:
a cloud processing environment having one or more processors and configured and programmed with a hotel service to execute the hotel service; and
the cloud processing environment or a different processing environment that dynamically delivers an app to a mobile device of a consumer;
wherein the hotel service is configured to register a hotel and collect an electronic version of a guest guide book that identifies information and services for the hotel, and the hotel service further configured to dynamically configure the app with the guest guide book and provide automated controlled access to the guest guide book via the app on the mobile device.

19. The system of claim 18, wherein the hotel service is further configured to register service providers associated with the hotel and track usage of a consumer of those service providers for reports to the hotel.

20. The system of claim 18, wherein the hotel service is further configured to configure the app to deliver navigation services, search services, and recommendation services for establishments within a geographic proximity to the hotel.
